(19) United States
(12) Patent Application Publication
(10) Pub. No.: US 2011/0072479 A1
(43) Pub. Date: Mar. 24, 2011

(54) SYSTEM AND METHOD FOR REPORTING A POSITION OF A VIDEO DEVICE AND NETWORK VIDEO TRANSMITTER THEREOF

(75) Inventors: Chien-Chih Hsu, Yilan County (TW); Hsin-Ta Chiao, Nantou County (TW); Yu-Kai Chen, Taichung County (TW)

(73) Assignee: INDUSTRIAL TECHNOLOGY RESEARCH INSTITUTE, Hsinchu (TW)

(21) Appl. No.: 12/880,171

(22) Filed: Sep. 13, 2010

Related U.S. Application Data
(60) Provisional application No. 61/245,016, filed on Sep. 23, 2009.

(30) Foreign Application Priority Data
Jul. 23, 2010 (TW) 99124320

(51) Int. Cl. H04N 5/225; H04N 7/173

(52) U.S. Cl. 725/110; 348/207.1; 348/E05.024

(57) ABSTRACT

A system and method for reporting the position of a video device is provided. The system includes a network video transmitter and a network video client. The network video transmitter is configured for capturing a series of video frames and transmitting the video frames via a network. The network video transmitter includes a geographical coordinate detecting device for detecting geographical coordinate information corresponding to the network video transmitter. The network video client is configured for receiving the video frames via the network, wherein the geographical coordinate information corresponding to the network video transmitter is transmitted to the network video client. Accordingly, the system and method is capable of providing the geographical coordinate information corresponding to a video frame captured by the network video transmitter.

### CROSS-REFERENCE TO RELATED APPLICATION

This application claims the priority benefits of U.S. provisional application Ser. No. 61/245,016, filed on Sep. 23, 2009 and Taiwan patent application serial no. 99124320, filed on Jul. 23, 2010. The entirety of each of the above-mentioned patent applications is hereby incorporated by reference herein and made a part of specification.

### BACKGROUND

1. Field of the Disclosure

The disclosure relates to a system and a method for reporting the position of a video device. More particularly, the disclosure relates to a system and a method for reporting the position of a mobile video device, as well as a network video transmitter using such method.

2. Description of Related Art

Along with the development of wireless communication technologies, various mobile devices can be easily connected to the Internet. A mobile Internet protocol (IP) camera is connected to the Internet through a wireless communication technique (for example, WiMAX, 3G or long term evolution (LTE), etc.), so as to transmit video streams captured on the move to a client or a back-end server. For example, the mobile IP cameras can be used for military reconnaissance, rescue search, police patrols, traffic status notification, and pollution investigation, etc.

Conventionally, a camera of a video surveillance system is disposed at a fixed position, so that a user can clearly know the position where the video frames are captured. However, since the mobile IP camera captures video frames in a mobile approach, a client user has to identify the position of a captured video frame through specific buildings or other landmarks on the video frame. Therefore, regarding such video frames, it is inconvenient to identify the position of each video frame to be captured.

### SUMMARY

The disclosure is directed to a system and a method for reporting the position of a video device, which can report geographic coordinate information corresponding to the position of a network video transmitter.

The disclosure is directed to a network video transmitter, which can report geographic coordinate information of the current position where video frames are taken.

An exemplary embodiment of the disclosure provides a system for reporting the position of a video device. The system includes a network video transmitter and a network video client. The network video transmitter is configured for taking a video frame and transmitting the video frame through a network. The network video transmitter includes a geographic coordinate detecting device for detecting geographic coordinate information corresponding to the network video transmitter. The network video client is configured for receiving the video frame through the network, wherein the network video transmitter transmits the geographic coordinate information corresponding to the network video transmitter to the network video client through the network.

An exemplary embodiment of the disclosure provides a method for reporting the position of a video device, which is used for reporting the geographic coordinate information corresponding to a network video transmitter to a network video client. The method for reporting the position of a video device includes detecting the geographic coordinate information corresponding to the network video transmitter, and transmitting the geographic coordinate information corresponding to the network video transmitter to the network video client through a network.

An exemplary embodiment of the disclosure provides a network video transmitter including an image sensor, a geographic coordinate detecting device, a communication interface and a position reporting module. The image sensor is configured for taking a video frame. The geographic coordinate detecting device is configured for detecting geographic coordinate information. The position reporting module is coupled to the image sensor, the geographic coordinate detecting device and the communication interface, and is configured for transmitting the geographic coordinate information through the communication interface by using a web service discovery procedure.

An exemplary embodiment of the disclosure provides a network video transmitter including an image sensor, a geographic coordinate detecting device, a communication interface and a position reporting module. The image sensor is configured for taking a video frame. The geographic coordinate detecting device is configured for detecting geographic coordinate information. The position reporting module is coupled to the image sensor, the geographic coordinate detecting device and the communication interface, and is configured for transmitting the geographic coordinate information through the communication interface by using a Real-time Transport Protocol (RTP) streaming service.

An exemplary embodiment of the disclosure provides a method for reporting the position of a video device, which is used for reporting geographic coordinate information corresponding to a network video transmitter to a network video client. The method for reporting the position of a video device includes detecting the geographic coordinate information corresponding to the network video transmitter, defining a geographic coordinate attribute in a location scope of a hello message of a web service discovery procedure, and transmitting the geographic coordinate information to the network video client through the geographic coordinate attribute.

An exemplary embodiment of the disclosure provides a method for reporting the position of a video device, which is used for reporting geographic coordinate information corresponding to a network video transmitter to a network video client. The method for reporting the position of a video device includes detecting the geographic coordinate information corresponding to the network video transmitter, and transmitting the geographic coordinate information to the network video client through a Real-time Transport Protocol (RTP) streaming service.

According to the above descriptions, the geographic coordinate information of the network video transmitter can be reported to the network video client, so as to effectively identify the position where a video frame is captured.

In order to make the aforementioned and other features and advantages of the disclosure comprehensible, several exemplary embodiments accompanied with figures are described in detail below.

### BRIEF DESCRIPTION OF THE DRAWINGS

The accompanied drawings are included to provide a further understanding of the disclosure, and are incorporated in and constitute a part of this specification. The drawings illustrate the embodiments of the disclosure and serve to explain the principles of the disclosure in together with the description.

FIG. 1 is a schematic block diagram illustrating a system for reporting the position of a video device according to the first exemplary embodiment of the disclosure.

FIG. 2 is a schematic block diagram illustrating a system for reporting the position of a video device according to another exemplary embodiment of the disclosure.

FIG. 3A is a schematic block diagram illustrating a network video transmitter according to the first exemplary embodiment of the disclosure.

FIG. 3B is a schematic block diagram illustrating a network video transmitter according to another exemplary embodiment of the disclosure.

FIG. 4 is a schematic diagram illustrating an example of reporting geographic coordinate information through a hello message according to the first exemplary embodiment of the disclosure.

FIG. 5 is a flowchart illustrating a method for reporting the position of a video device according to the first exemplary embodiment of the disclosure.

FIG. 6 is a schematic diagram of an XML schema used for recording the geographic coordinate information in a location information stream according to the second exemplary embodiment of the disclosure.

FIG. 7 is a schematic diagram illustrating an example of reporting geographic coordinate information through a Real-time Transport Protocol (RTP) metadata stream according to the second exemplary embodiment of the disclosure.

FIG. 8 is a flowchart illustrating a method for reporting the position of a video device according to the second exemplary embodiment of the disclosure.

FIG. 9 is a schematic diagram illustrating an example of an RTP packet according to the third exemplary embodiment of the disclosure.

FIGS. 10A and 10B are schematic diagrams illustrating a 32-bit representing method according to the third exemplary embodiment of the disclosure.

FIG. 11 is a flowchart illustrating a method for reporting the position of a video device according to the third exemplary embodiment of the disclosure.

FIG. 12 is a schematic diagram illustrating an RTP packet according to another exemplary embodiment of the disclosure.

### DETAILED DESCRIPTION OF DISCLOSED EMBODIMENTS

In the disclosure, geographic coordinate information of a network video transmitter can be transmitted to a network video client (for example, a back-end processing server) through a network during a communication process between the network video transmitter and the network video client, so as to identify the position where a video frame is captured by the network video transmitter. A plurality of exemplary embodiments is provided below to describe the disclosure in detail.

### The First Exemplary Embodiment

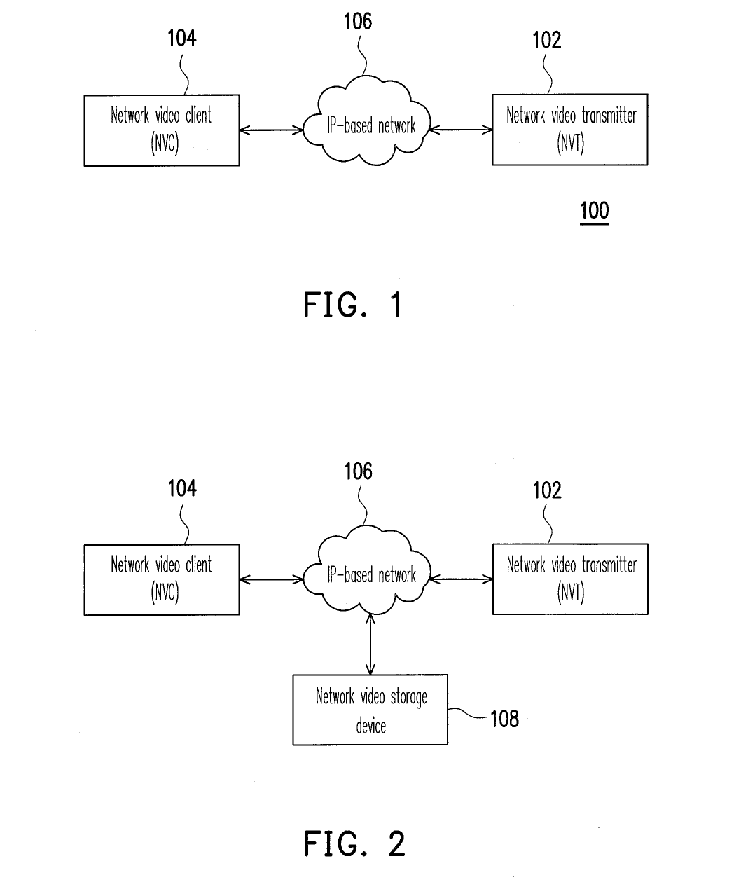

FIG. 1 is a schematic block diagram illustrating a system for reporting the position of a video device according to the first exemplary embodiment of the disclosure.

Referring to FIG. 1, the system for reporting the position of a video device (hereafter referred to as the system 100) includes an Network Video Transmitter (NVT) 102 and an Network Video Client (NVC) 104.

The NVT 102 is configured for capturing a video frame and then transmitting the video frame to the NVC 104. For example, the NVT 102 is a mobile Internet Protocol (IP) camera, a video encoding device or other video/audio capturing devices. The NVC 104 is configured for receiving the video frame from the NVT 102. Particularly, the NVT 102 reports its own geographic coordinate information to the NVC 104 according to a method for reporting the position of a video device disclosed in the exemplary embodiment of the disclosure.

In the present exemplary embodiment, the NVT 102 and the NVC 104 are complied with an Open Network Video Interface Forum (ONVIF) specification. In the ONVIF specification, the NVT 102 and the NVC 104 are mutually communicated through a web service, and transmit video frames (i.e. video streams) according to a Real-time Transport Protocol (RTP). Here, the web service is a machine to machine communication interface in an IP-based network, which can be formed by components such as a Simple Object Access Protocol (SOAP) component, a Web Service Description Language (WSDL) component and a Universal Description Discovery and Integration (UDDI) component based on an eXtensible Markup Language (XML).

Moreover, the NVT 102 and the NVC 104 are mutually communicated by exchanging IP packets through an IP-based network 106. For example, the video frames captured by the NVT 102 are transmitted to the NVC 104 through the IP-based network 106.

In the IP-based network 106, the NVT 102 and the NVC 104 can be simultaneously located in either a public network or an administrative domain. Otherwise, the NVT 102 and the NVC 104 can be respectively located in a public network and in an administrative domain.

It should be noticed that in another exemplary embodiment of the disclosure, the system 100 further includes a network video storage device 108 (shown in FIG. 2). The network video storage device 108 is configured for directly receiving the video frames from the NVT 102 or indirectly receiving the video frames captured by the NVT 102 from the NVC 104, and storing the received video frames.

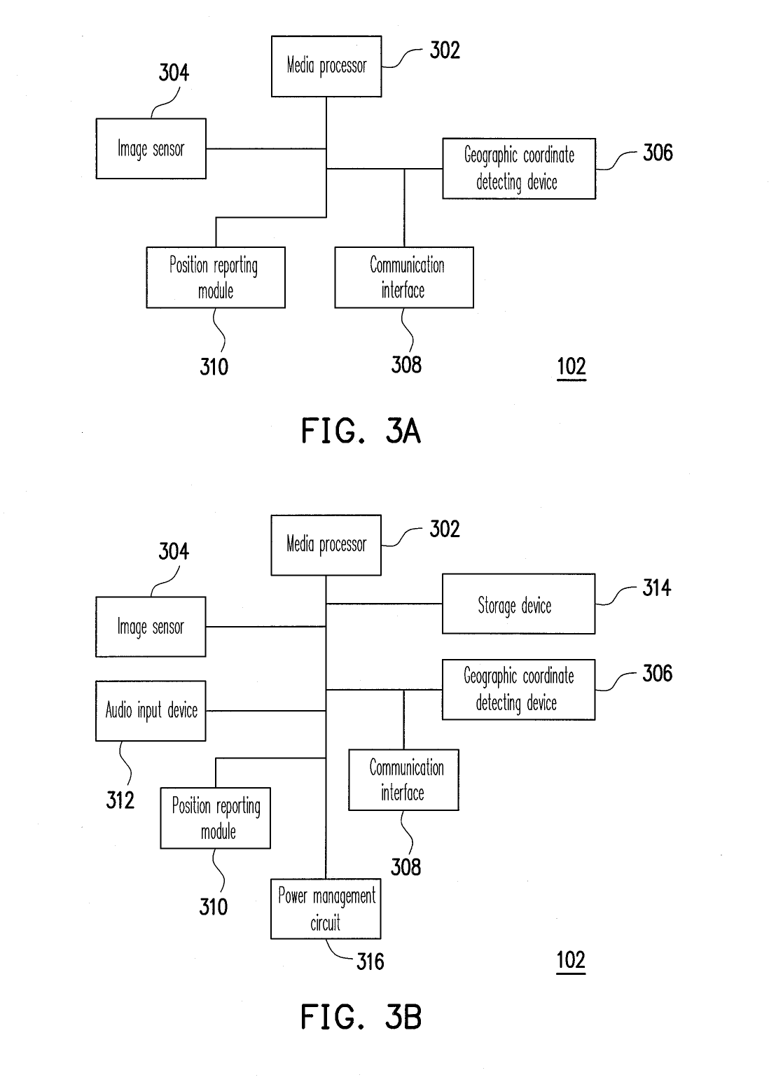

FIG. 3A is a schematic block diagram illustrating an NVT according to the first exemplary embodiment of the disclosure.

Referring to FIG. 3A, the NVT 102 includes a media processor 302, an image sensor 304, a geographic coordinate detecting device 306, a communication interface 308 and a position reporting module 310.

The media processor 302 is configured for controlling the whole operation of the NVT 102.

The image sensor 304 is coupled to the media processor 302, and is configured for capturing video frames. For example, the image sensor 304 is a Charge-Coupled Device (CCD) image sensor or a Complementary Metal-Oxide Semiconductor (CMOS) image sensor.

The geographic coordinate detecting device 306 is coupled to the media processor 302, and is configured for detecting geographic coordinate information. In the present exemplary embodiment, the geographic coordinate detecting device 306 supports the Global Positioning System (GPS), so as to receive position information from a plurality of satellites to calculate the geographic coordinate information corresponding to the NVT 102. However, it should be noticed that the disclosure is not limited thereto, and in another exemplary embodiment, the geographic coordinate detecting device 306 can also support the Galileo positioning system, the GLObal NAvigation Satellite System (GLONASS) or the Assisted Global Positioning System (AGPS).

It should be noticed that in the present exemplary embodiment, the geographic coordinate detecting device 306 is integrated in the NVT 102, but the disclosure is not limited thereto. For example, in another exemplary embodiment of the disclosure, the geographic coordinate detecting device 306 can also be independently disposed at the external of the NVT 102, and is coupled to the NVT 102 through a suitable interface.

The communication interface 308 is coupled to the media processor 302, and is configured for transmitting and receiving data through the IP-based network 106. Here, the communication interface 308 can be an Ethernet interface, or other wireless communication interfaces. For example, the wireless version of the communication interface 308 is complied with a WiMAX specification, a Wi-Fi specification, a WLAN specification or other wireless communication specifications. Particularly, in case that the NVT 102 and the NVC 104 are complied with the ONVIF specification, the communication interface 308 transmits data according to the ONVIF specification.

The position reporting module 310 is coupled to the media processor 302, and is configured for transmitting the geographic coordinate information detected by the geographic coordinate detecting device 306 through the communication interface 308 according to the method for reporting a position of a video device in the exemplary embodiment of the disclosure.

In another exemplary embodiment of the disclosure, the NVT 102 further includes an audio input device 312, a storage device 314 and a power management circuit 316 (shown in FIG. 3B).

The audio input device 312 is coupled to the media processor 302, and is configured for sound capturing. The storage device 314 is coupled to the media processor 302, and is configured for storing data (for example, the video frames captured by the image sensor 304, the audio data captured by the audio input device 312, and the geographic coordinate information detected by the geographic coordinate detecting device 306, etc.). The power management circuit 316 is coupled to the media processor 302, and is configured for managing the supply of power in the NVT 102.

As described above, the NVT 102 and the NVC 104 are mutually communicated through the web service. Therefore, when the NVT 102 enables the web service, the NVT 102 may enable a web service discovery procedure through the UDDI component to release and register the web service. In the web service discovery procedure, the NVT 102 may transmit a hello message through the IP-based network 106 to start communicating with the NVC 104.

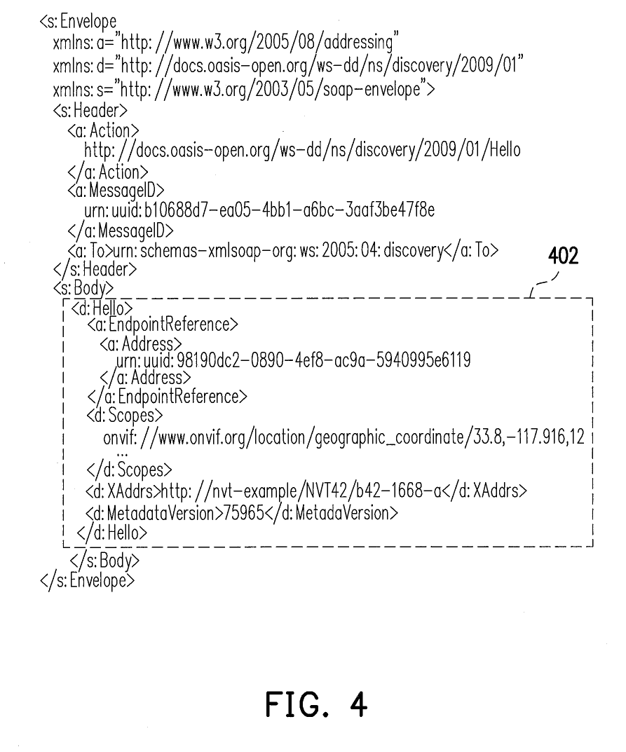

FIG. 4 is a schematic diagram illustrating an example of reporting the geographic coordinate information through the hello message according to the first exemplary embodiment of the disclosure.

Referring to FIG. 4, the hello message 402 includes a location scope, i.e. “onvif://www.onvif.org/location/”. Particularly, in the present exemplary embodiment, a geographic coordinate attribute is defined for recording the geographic coordinate information in the location scope. For example, a proposed name of the geographic coordinate attribute is “geographic_coordinate”, and the parameters of latitude, longitude and altitude of the geographic coordinate information are recorded in the geographic coordinate attribute in the form of plain text. As shown in the example of FIG. 4, “onvif://www.onvif.org/location/geographic_coordinate/33.8,−117.916,12” represents that the latitude of the geographic coordinate information of the NVT 102 is 33.8, the longitude thereof is −117.916, and the altitude thereof is 12. It should be noticed that in the geographic coordinate attribute, the altitude can be expressed in meters or feet. The unit of altitude can be provided by the NVT in an out-of-band approach. For example, a new web service with the name “GetAltituteUnit” is provided by the NVT, and this web service can return whether the unit of altitude employed by the NVT is meters or feet.

Accordingly, when the NVT 102 enables its web service, the position reporting module 310 records the geographic coordinate information currently detected by the geographic coordinate detecting device 306 in the location scope of the hello message 402, and the hello message 402 containing the geographic coordinate information is transmitted through the IP-based network 106, so that the NVC 104 can identify the location scope of the hello message 402 to obtain the geographic coordinate information corresponding to the NVT 102.

It should be noticed that the hello message 402 is only transmitted during an initialisation phase of the web service. In another exemplary embodiment of the disclosure, a parameter “variable” is further defined in the geographic coordinate attribute to show whether the NVT 102 is a mobile device or not. In detail, during the web service discovery procedure, the NVT 102 adds a description of “onvif://www.onvif.org/location/geographic_coordinate/variable” in the location scope of the hello message 402 to notify the other devices in the IP-based network 106 that the position of the NVT 102 is variable (i.e. the NVT is movable).

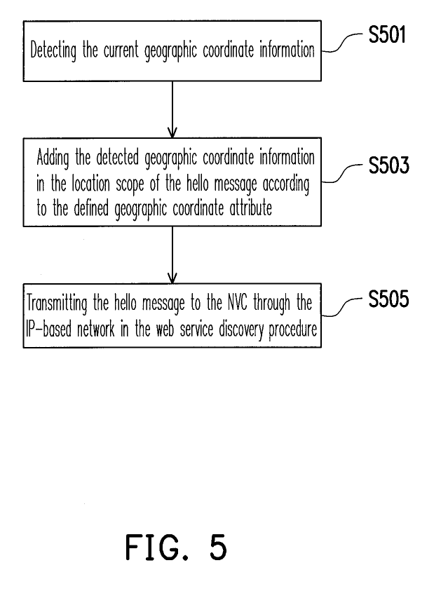

FIG. 5 is a flowchart illustrating a method for reporting a position of a video device according to the first exemplary embodiment of the disclosure.

Referring to FIG. 5, in step S501, the NVT 102 detects the current geographic coordinate information. For example, the geographic coordinate detecting device 306 calculates the geographic coordinate information corresponding to the NVT 102 according to information received from the satellites.

In step S503, the position reporting module 310 of the NVT 102 adds the detected geographic coordinate information in the location scope of the hello message 402 according to the defined geographic coordinate attribute.

Next, in step S505, the position reporting module 310 of the NVT 102 transmits the hello message 402 to the NVC 104 through the IP-based network 106 in the web service discovery procedure.

It should be noticed that in the present exemplary embodiment, the geographic coordinate information corresponding to the NVT 102 is transmitted through the hello message in the web service discovery procedure, but the disclosure is not limited thereto. In another exemplary embodiment, the geographic coordinate information corresponding to the NVT 102 can also be transmitted through other communication messages in the web service discovery procedure.

### The Second Exemplary Embodiment

A structure of a system for reporting the position of a video device in the second exemplary embodiment is substantially the same to that of the system for reporting the position of the video device in the first exemplary embodiment, and the differences between them are that in the second exemplary embodiment, the geographic coordinate information is transmitted through a metadata stream of a Real-time Transport Protocol (RTP) streaming service. Only the differences between the second exemplary embodiment and the first exemplary embodiment are described with reference to FIG. 1 and FIG. 3 in the following.

As described above, the NVT 102 and the NVC 104 transmit the video frames (i.e. the video streams) according to the RTP specifications. In the present exemplary embodiment, the geographic coordinate information corresponding to the NVT 102 is transmitted through the metadata stream within the RTP streaming service.

To be specific, the metadata stream is delivered by a series of RTP packet in which the XML-based metadata are carried in the payload of the RTP packets. Particularly, in the present exemplary embodiment, the metadata transmitted by the RTP metadata stream contains a location information stream type declared by a complex type component of XML schema, so as to provide a format required for recording the geographic coordinate information.

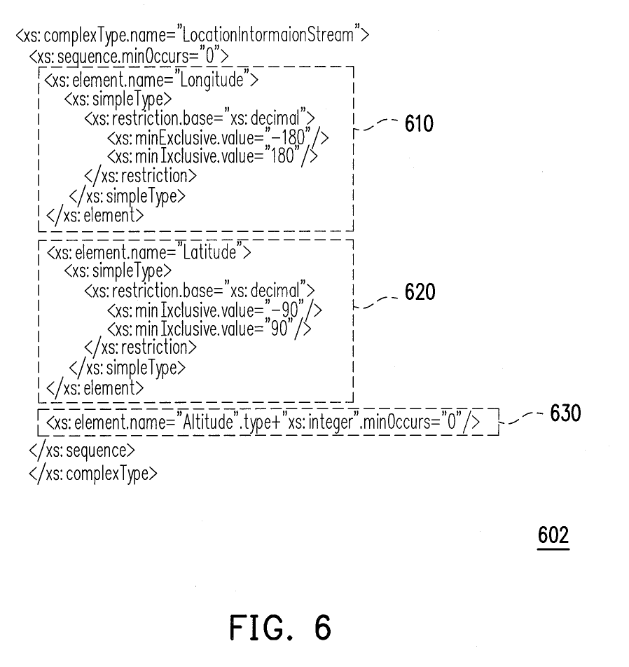

FIG. 6 is a schematic diagram of the XML schema used for recording the geographic coordinate information according to the second exemplary embodiment of the disclosure.

Referring to FIG. 6, a name of the location information stream type 602 is “LocationInformationStream”. In the location information stream type 602, a component named “longitude” is declared to record the longitude of the geographic coordinate information, and the longitude has a range of value from “−180” to “180” (shown by a dot line 610). Moreover, in the location information stream type 602, a component named “latitude” is declared to record the latitude of the geographic coordinate information, and the latitude has a range of value from “−90” to “90” (shown by a dot line 620). Moreover, in the location information stream type 602, a component named “altitude” is declared to record the altitude of the geographic coordinate information (shown by a dot line 630). The unit of altitude can be provided by the NVT in an out-of-band approach. For example, a new web service with the name “GetAltituteUnit” is provided by the NVT, and this web service can return whether the unit of altitude employed by the NVT is meters or feet.

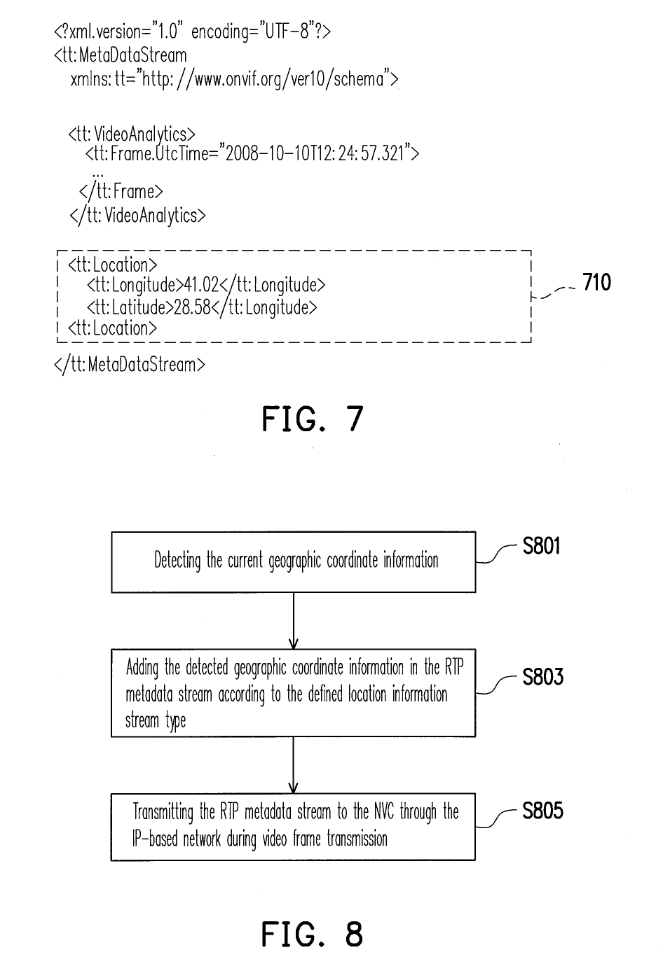

FIG. 7 is a schematic diagram illustrating an example of the metadata for reporting the geographic coordinate information through the RTP metadata stream according to the second exemplary embodiment of the disclosure.

Referring to FIG. 7, the geographic coordinate information is added in a metadata stream 702 according to the location information stream type 602 defined in FIG. 6, wherein the longitude of the geographic coordinate information corresponding to the NVT 102 is 41.02, and the latitude thereof is 28.58 (shown by a dot line 710). Furthermore, in another embodiment of the present disclosure, the version number “ver10” in the XML namespace “http://www.onvif.org/ver10/schema” in FIG. 7 can be changed to other version numbers.

In this way, when the NVT 102 transmits the video frames, the position reporting module 310 records the geographic coordinate information currently detected by the geographic coordinate detecting device 306 in the RTP metadata stream 702, and the RTP metadata stream 702 containing the geographic coordinate information is transmitted through the IP-based network 106, so that the NVC 104 can identify the geographic coordinate information recorded in the RTP metadata stream 702, so as to obtain the positions where the video frames are captured. Furthermore, the relationship between a copy of the geographic coordinate information and a captured video frame is expressed and maintained by RTCP (Real-time Transport Control Protocol) according to both the RTP timestamp in the header of the RTP packet that contains the copy of the geographic coordinate information and the RTP timestamp in the header of the RTP packet that contains the captured video frame.

FIG. 8 is a flowchart illustrating a method for reporting the position of a video device according to the second exemplary embodiment of the disclosure.

Referring to FIG. 8, in step S801, the NVT 102 detects the current geographic coordinate information. For example, the geographic coordinate detecting device 306 calculates the geographic coordinate information corresponding to the NVT 102 according to information received from the satellites.

In step S803, the position reporting module 310 of the NVT 102 adds the detected geographic coordinate information in the RTP metadata stream 702 according to the defined location information stream type.

Next, in step S805, the position reporting module 310 of the NVT 102 transmits the RTP metadata stream 702 to the NVC 104 through the IP-based network 106 during video frame transmission.

### The Third Exemplary Embodiment

The structure of a system for reporting the position of a video device in the third exemplary embodiment is substantially the same to that of the system for reporting the position of the video device in the first exemplary embodiment, and the differences between them are that in the third exemplary embodiment, the geographic coordinate information is transmitted through an RTP header extension in an RTP packet. Only the differences between the third exemplary embodiment and the first exemplary embodiment are described with reference of FIG. 1 and FIG. 3 in the following.

As described above, the NVT 102 and the NVC 104 transmit the video frames (i.e. the video streams) according to the RTP specifications. In the present exemplary embodiment, the geographic coordinate information corresponding to the NVT 102 is transmitted through an RTP header extension of a packet transmitted by the RTP streaming service. To be specific, when the RTP is employed to transmit a video frame or audio data, a transmitter adds an RTP header to the video frame (or a fragment of the video frame) or the audio data to form an RTP packet. Then, a receiver can correctly decode and play the received video frame or the audio data according to the RTP header (or the related RTP headers if the video frame is transmitted in multiple fragments). For example, the RTP header includes several fixed fields of bits for recording the information related to the video frame or the audio data. Particularly, in the fixed part of the RTP header, an extension bit is defined to indicate that the RTP header contains a header extension. In the present exemplary embodiment, a binary coded coordinate header extension is defined in the RTP header to transmit the geographic coordinate information corresponding to the NVT 102.

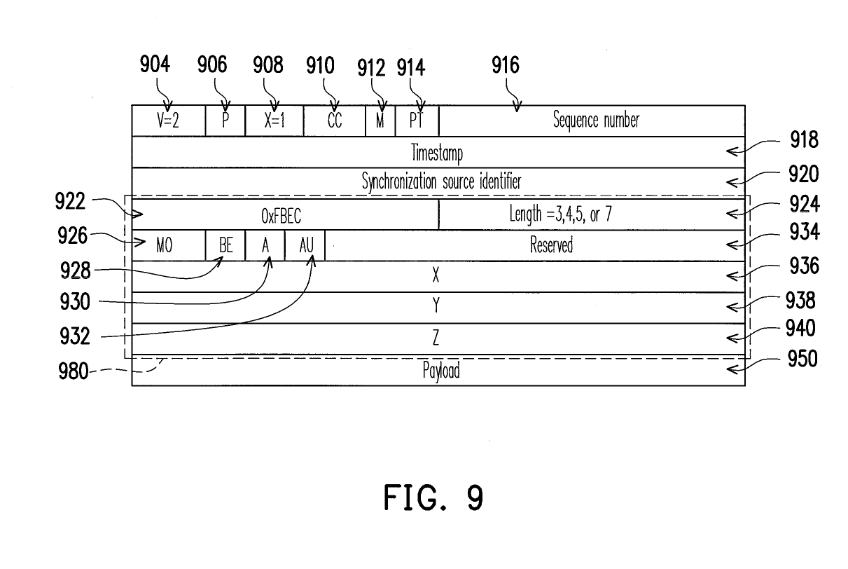

FIG. 9 is a schematic diagram illustrating an example of a RTP packet according to the third exemplary embodiment of the disclosure.

Referring to FIG. 9, the RTP packet 900 includes a RTP header 902 and a payload 950. The RTP header 902 is used for recording related information of the RTP packet 900, and the payload 950 is for storing the user data to be transmitted (For example, the video frame).

The RTP header 902 includes a version information field 904, a padding field 906, an extension field 908, a CSRC (Contributing SouRCe) count field 910, a marker field 912, a payload type field 914, a sequence number field 916, a timestamp field 918 and an SSRC (Synchronization SouRCe) identifier field 920.

The version information field 902 has 2 bits for recording the version of RTP. The padding field 906 has 1 bit for recording whether the end of the packet contains padding bits. The extension field 908 has 1 bit for recording whether the RTP header includes a header extension. The CSRC count field 910 has 4 bits for recording the number of CSRC. The marker field 912 has 1 bit for marking the information to be explained by the user. The payload type field 914 has 7 bits for recording the type of the RTP payload. The sequence number field 916 has 16 bits for recording a serial number of the RTP packet. The timestamp field 918 has 32 bits for recording a sampling time of the RTP packet. The SSRC identifier field 920 has 32 bits for recording the identifier of the synchronization source.

Particularly, if an RTP header 902 contains a binary coded coordinate header extension 980, the extension field 908 of the RTP header 902 is marked by “1”.

The binary coded coordinate header extension 980 has an identifier field 922, an extension header length field 924, a mobility field (MO) 926, an encoding method field (BE) 928, an altitude identification field (A) 930, an altitude unit field (AU) 932, a reserved field 934, a longitude field (X) 936, a latitude field (Y) 938 and an altitude field (Z) 940.

The identifier field 922 has 16 bits for recording an identification value of the binary coded coordinate header extension 980. For example, the identification value of the binary coded coordinate header extension 980 is “0xFBEC” in hexadecimal integer representation.

The extension header length field 924 has 16 bits for recording the length of the binary coded coordinate header extension 980. In detail, the extension header length field 924 records the number of 32-bit words belonged to the binary coded coordinate header extension 980 behind the extension header length field 924.

The mobility field 926 has 1 bit for recording whether the NVT 102 is a fixed device or a mobile device. For example, when the mobility field 926 is marked by “0”, it represents that the NVT 102 is a fixed device. When the mobility field 926 is marked by “1”, it represents that the NVT 102 is a mobile device.

The encoding method field 928 has 1 bit for recording whether the longitude filed 936, the latitude field 938 and the altitude field 940 are of a 32-bit representation or a 64-bit representation. For example, when the encoding method field 928 is marked by “0”, it means that the longitude filed 936, the latitude field 938 and the altitude field 940 are of the 32-bit representation. In contrast, when the encoding method field 928 is marked by “1”, it means that the longitude filed 936, the latitude field 938 and the altitude field 940 are of the 64-bit representation.

In detail, when the encoding method field 928 is marked by “1”, it means that the longitude filed 936, the latitude field 938 and the altitude field 940 are represented by the format of the 64-bit floating numbers defined in IEEE 764 specification. Moreover, when the encoding method field 928 is marked by “0”, it means that the longitude filed 936, the latitude field 938 and the altitude field 940 are represented by a 32-bit representation method designed by the exemplary embodiment of the disclosure.

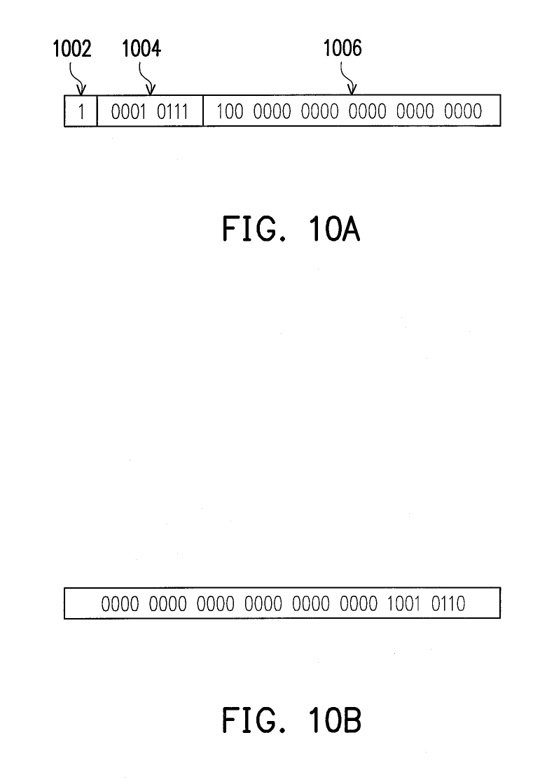

FIGS. 10A and 10B are schematic diagrams illustrating the 32-bit representation method according to the third exemplary embodiment of the disclosure.

Referring to FIG. 10A, according to the 32-bit representation method, a sign field 1002, an integer field 1004 and a decimal field 1006 are used to represent the longitude and the latitude.

The sign field 1002 has 1 bit for recording a plus sign (positive sign) or a minus sign (negative sign) of the longitude (or the latitude). For example, when the sign field 1002 is marked by “0”, it represents the plus sign, and when the sign field 1002 is marked by “1”, it represents the minus sign. The integer field 1004 has 8 bits for recording the integer part of the longitude (or the latitude). The decimal field 1006 has 23 bits for recording the decimal part of the longitude (or the latitude). A method for calculating the value represented by the decimal part is to treat the 23-bit decimal field as an integer, and then the integer is divided by 2²³. For example, “−23.5” is represented by “1 0001 0111 100 0000 0000 0000 0000 0000” if the 32-bit representation method for longitude and latitude is employed.

Referring to FIG. 10B, the 32-bit representing method uses 2's complement to represent the altitude. For example, “150” is represented by “0000 0000 0000 0000 0000 0000 1001 0110”.

Referring to FIG. 9 again, the altitude identification field 930 has 1 bit for recording whether the geographic coordinate information contains the altitude information. For example, when the altitude identification field 930 is marked by “0”, it represents that the geographic coordinate information does not contain the altitude information, and when the altitude identification field 930 is marked by “1”, it represents that the geographic coordinate information contains the altitude information.

The altitude unit field 932 has 1 bit for recording the unit of the altitude. For example, when the altitude unit field 932 is marked by “0”, it represents that the altitude is expressed by meters, and when the altitude unit field 932 is marked by “1”, it represents that the altitude is expressed by feet.

The reserved field 934 has 28 bits. The longitude field 936, the latitude field 938 and the altitude field 940 are respectively used for recording the longitude, the latitude and the altitude of the geographic coordinate information.

According to the above configuration, the extension header length field 924 can be set according to different situations. In the present exemplary embodiment, the extension header length field 924 can be marked by 3, 4, 5 or 7.

In detail, if the transmitted geographic coordinate information does not contain the altitude information, and the longitude and the latitude are represented by the 32-bit representation method, the length of the binary coded coordinate header extension 980 is 96 bits. Consequently, the extension header length field 924 is marked by 3.

If the transmitted geographic coordinate information contains the altitude information, and the longitude and the latitude are represented by the 32-bit representation method, the length of the binary coded coordinate header extension 980 is 128 bits. Consequently, the extension header length field 924 is marked by 4.

If the transmitted geographic coordinate information does not contain the altitude information, and the longitude and the latitude are represented by the 64-bit representation method, the length of the binary coded coordinate header extension 980 is 160 bits. Consequently, the extension header length field 924 is marked by 5.

If the transmitted geographic coordinate information contains the altitude information, and the longitude and the latitude are represented by the 64-bit representation method, the length of the binary coded coordinate header extension 980 is 224 bits. Consequently, the extension header length field 924 is marked by 7.

According to the above descriptions, in the exemplary embodiment of the disclosure, during the process of transmitting the video frames, the geographic coordinate information of the NVT 102 is transmitted to the NVC 104 through the IP-based network 106 by using the binary coded coordinate header extension 980 of the RTP header 902.

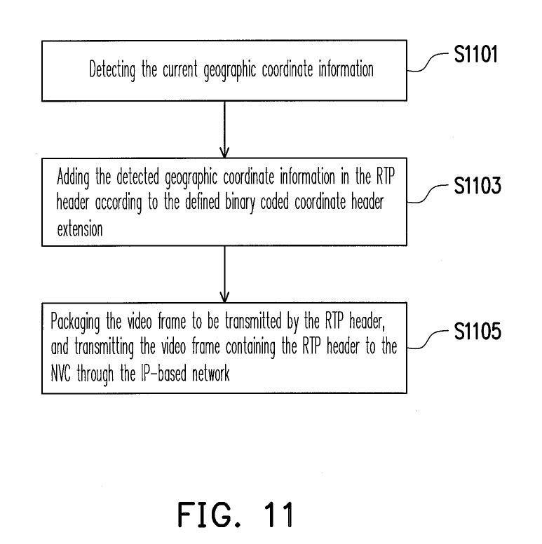

FIG. 11 is a flowchart illustrating a method for reporting the position of a video device according to the third exemplary embodiment of the disclosure.

Referring to FIG. 11, in step S1101, the NVT 102 detects the current geographic coordinate information. For example, the geographic coordinate detecting device 306 calculates the geographic coordinate information corresponding to the NVT 102 according to information received from the satellites.

In step S1103, the position reporting module 310 of the NVT 102 adds the detected geographic coordinate information in the RTP header according to the defined binary coded coordinate header extension 980.

Next, in step S1105, the NVT 102 packetizes the video frame to be transmitted by the RTP header, and transmits the video frame containing the RTP header to the NVC 104 through the IP-based network 106.

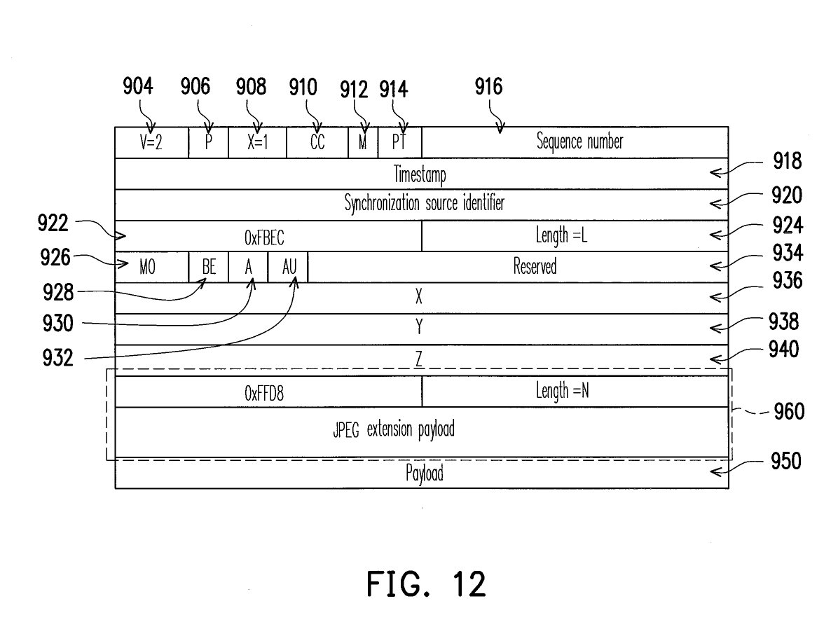

It should be noticed that in another exemplary embodiment of the disclosure, in the binary coded coordinate header extension 980, other header extension can be further defined, so as to transmit the other related information. For example, an RTP header extension for Joint Photographic Experts Group (JPEG) can be further included in the binary coded coordinate header extension 980. As shown in FIG. 12, an RTP header extension for JPEG 960 with the identifier of “0xFFD8” and the length of N is included in the binary coded coordinate header extension 980. It should be noticed that the value of the extension header length field 924 is equal to the length of the binary coded coordinate header extension 980 plus the length of the RTP header extension for JPEG 960.

In summary, the geographic coordinate information of the mobile NVT can be detected, and the detected geographic coordinate information can be transmitted to the NVC or a video storage device, so as to effectively identify the positions of the video frames captured by the mobile NVT.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A system for reporting the position of a video device, comprising:
a network video transmitter, for capturing a video frame and transmitting the video frame through a network, wherein the network video transmitter comprises a geographic coordinate detecting device for detecting geographic coordinate information corresponding to the network video transmitter; and
a network video client, for receiving the video frame through the network,
wherein the network video transmitter transmits the geographic coordinate information corresponding to the network video transmitter to the network video client through the network.

2. The system for reporting the position of a video device as claimed in claim 1, wherein the network video transmitter transmits the geographic coordinate information to the network video client through a web service discovery procedure.

3. The system for reporting the position of a video device as claimed in claim 2, wherein the web service discovery procedure comprises transmitting a hello message, and the geographic coordinate information is recorded in the hello message.

4. The system for reporting the position of a video device as claimed in claim 3, wherein the hello message has a location scope, and the location scope defines a geographic coordinate attribute to record the geographic coordinate information.

5. The system for reporting the position of a video device as claimed in claim 1, wherein the network video transmitter transmits the geographic coordinate information to the network video client through an Real-time Transport Protocol (RTP) streaming service.

6. The system for reporting the position of a video device as claimed in claim 5, wherein the Real-time Transport Protocol streaming service comprises a metadata stream, the metadata transmitted by the metadata stream contains an instance of a location information stream type, and the geographic coordinate information is recorded in the metadata according to the format of the location information stream type.

7. The system for reporting the position of a video device as claimed in claim 5, wherein a packet transmitted by the Real-time Transport Protocol streaming service comprises a binary coded coordinate header extension, the format of the binary coded coordinate header extension is a Real-time Transport Protocol header extension, and the geographic coordinate information is recorded in the binary coded coordinate header extension.

8. The system for reporting the position of a video device as claimed in claim 7, wherein the binary coded coordinate header extension comprises a Real-time Transport Protocol header extension for Joint Photographic Experts Group (JPEG).

9. The system for reporting the position of a video device as claimed in claim 1, wherein the network video transmitter is a mobile Internet protocol (IP) camera.

10. The system for reporting the position of a video device as claimed in claim 1, wherein the network video transmitter is complied with an Open Network Video Interface Forum specification, and the network video client is complied with the Open Network Video Interface Forum specification.

11. The system for reporting the position of a video device as claimed in claim 10, further comprising a network video storage device, wherein the network video storage device is complied with the Open Network Video Interface Forum specification, and receives the geographic coordinate information corresponding to the network video transmitter from the network video transmitter or the network video client.

12. The system for reporting the position of a video device as claimed in claim 1, wherein the geographic coordinate information comprises at least one of a latitude parameter, a longitude parameter and an altitude parameter.

13. A method for reporting the position of a video device, for reporting geographic coordinate information corresponding to a network video transmitter to a network video client, and the method for reporting the position of a video device comprising:
detecting the geographic coordinate information corresponding to the network video transmitter; and
transmitting the geographic coordinate information corresponding to the network video transmitter to the network video client through a network.

14. The method for reporting the position of a video device as claimed in claim 13, wherein the step of transmitting the geographic coordinate information corresponding to the network video transmitter to the network video client through the network comprises:
transmitting the geographic coordinate information to the network video client through a web service discovery procedure.

15. The method for reporting the position of a video device as claimed in claim 14, wherein the step of transmitting the geographic coordinate information to the network video client through the web service discovery procedure comprises:
defining a geographic coordinate attribute in a location scope of a hello message in the web service discovery procedure; and
transmitting the geographic coordinate information to the network video client through the geographic coordinate attribute.

16. The method for reporting the position of a video device as claimed in claim 13, wherein the step of transmitting the geographic coordinate information corresponding to the network video transmitter to the network video client through the network comprises:
transmitting the geographic coordinate information to the network video client through a Real-time Transport Protocol streaming service.

17. The method for reporting the position of a video device as claimed in claim 16, wherein the step of transmitting the geographic coordinate information to the network video client through the Real-time Transport Protocol streaming service comprises:
defining a location information stream type in the metadata transmitted by a metadata stream of the Real-time Transport Protocol streaming service;
recording the geographic coordinate information in the metadata according to a format of the location information stream type; and
transmitting the metadata stream containing the geographic coordinate information to the network video client.

18. The method for reporting the position of a video device as claimed in claim 16, wherein the step of transmitting the geographic coordinate information to the network video client through the Real-time Transport Protocol streaming service comprises:
defining a binary coded coordinate header extension in a Real-time Transport Protocol packet transmitted by the Real-time Transport Protocol streaming service, wherein the format of the binary coded coordinate header extension is a Real-time Transport Protocol header extension;
recording the geographic coordinate information in the binary coded coordinate header extension; and
transmitting the Real-time Transport Protocol streaming service containing the binary coded coordinate header extension to the network video client.

19. The method for reporting the position of a video device as claimed in claim 18, further comprising defining a Real-time Transport Protocol header extension for Joint Photographic Experts Group (JPEG) in the binary coded coordinate header extension.

20. The method for reporting the position of a video device as claimed in claim 13, wherein the geographic coordinate information comprises at least one of a latitude parameter, a longitude parameter and an altitude parameter.

21. A network video transmitter, comprising:
an image sensor, for capturing a video frame;
a geographic coordinate detecting device, for detecting geographic coordinate information;
a communication interface; and
a position reporting module, coupled to the image sensor, the geographic coordinate detecting device and the communication interface,
wherein the position reporting module is configured for transmitting the geographic coordinate information by a web service discovery procedure through the communication interface.

22. The network video transmitter as claimed in claim 21, wherein the web service discovery procedure comprises transmitting a hello message, and the geographic coordinate information is recorded in the hello message.

23. The network video transmitter as claimed in claim 22, wherein the hello message has a location scope, and the location scope defines a geographic coordinate attribute to record the geographic coordinate information.

24. The network video transmitter as claimed in claim 22, wherein the communication interface transmits data according to an Open Network Video Interface Forum specification.

25. A network video transmitter, comprising:
an image sensor, for capturing a video frame;
a geographic coordinate detecting device, for detecting geographic coordinate information;
a communication interface; and
a position reporting module, coupled to the image sensor, the geographic coordinate detecting device and the communication interface,
wherein the position reporting module is configured for transmitting the geographic coordinate information by a Real-time Transport Protocol (RTP) streaming service through the communication interface.

26. The network video transmitter as claimed in claim 25, wherein the Real-time Transport Protocol streaming service comprises a metadata stream, the metadata transmitted by the metadata stream contains an instance of a location information stream type, and the geographic coordinate information is recorded in the metadata according to the format of the location information stream type.

27. The network video transmitter as claimed in claim 25, wherein the Real-time Transport Protocol streaming service comprises a binary coded coordinate header extension, the format of the binary coded coordinate header extension is a Real-time Transport Protocol header extension, and the geographic coordinate information is recorded in the binary coded coordinate header extension.

28. The network video transmitter as claimed in claim 27, wherein the binary coded coordinate header extension comprises a Real-time Transport Protocol header extension for Joint Photographic Experts Group (JPEG).

29. The network video transmitter as claimed in claim 25, wherein the communication interface transmits a video frame and data according to an Open Network Video Interface Forum specification.

30. The network video transmitter as claimed in claim 25, wherein the geographic coordinate information comprises at least one of a latitude parameter, a longitude parameter and an altitude parameter.

31. A method for reporting the position of a video device, for reporting geographic coordinate information corresponding to a network video transmitter to a network video client, and the method for reporting the position of a video device comprising:
detecting the geographic coordinate information corresponding to the network video transmitter;
defining a geographic coordinate attribute in a location scope of a hello message in a web service discovery procedure; and
transmitting the geographic coordinate information to the network video client through the geographic coordinate attribute.

32. A method for reporting the position of a video device, for reporting geographic coordinate information corresponding to a network video transmitter to a network video client, and the method for reporting the position of a video device comprising:
detecting the geographic coordinate information corresponding to the network video transmitter; and
transmitting the geographic coordinate information to the network video client through a Real-time Transport Protocol (RTP) streaming service.

33. The method for reporting the position of a video device as claimed in claim 32, wherein the step of transmitting the geographic coordinate information to the network video client through the Real-time Transport Protocol streaming service comprises:
defining a location information stream type in the metadata transmitted by a metadata stream of the Real-time Transport Protocol streaming service;
recording the geographic coordinate information in the metadata according to the format of the location information stream type; and
transmitting the metadata stream containing the geographic coordinate information to the network video client.

34. The method for reporting the position of a video device as claimed in claim 32, wherein the step of transmitting the geographic coordinate information to the network video client through the Real-time Transport Protocol streaming service comprises:
defining a binary coded coordinate header extension in a Real-time Transport Protocol packet transmitted by the Real-time Transport Protocol streaming service, wherein the format of the binary coded coordinate header extension is a Real-time Transport Protocol header extension;
recording the geographic coordinate information in the binary coded coordinate header extension; and
transmitting the Real-time Transport Protocol streaming service containing the binary coded coordinate header extension to the network video client.

35. The method for reporting the position of a video device as claimed in claim 34, further comprising defining a Real-time Transport Protocol header extension for Joint Photographic Experts Group (JPEG) in the binary coded coordinate header extension.
